(19) United States
(12) Patent Application Publication
(10) Pub. No.: US 2003/0039214 A1
(43) Pub. Date: Feb. 27, 2003

(54) Method for determining the end of transmission in a software radio having multiple processors

(76) Inventor: Amber D. Huffman, Banks, OR (US)

Correspondence Address: Mark L. Watson, BLAKELY, SOKOLOFF, TAYLOR & ZAFMAN LLP, 7th Floor, 12400 Wilshire Boulevard, Los Angeles, CA, 90025-1026, US

(21) Appl. No.: 09/939,347

(22) Filed: Aug. 24, 2001

(51) Int. Cl. H04L 12/28

(52) U.S. Cl. 370/252; 370/389

(57) ABSTRACT

According to one embodiment, a method is disclosed. The method includes transmitting data symbols from a media access control layer (MAC) processing element to a second processor and monitoring a receive signal strength indicator (RSSI) value to determine if the data symbols have been completely transmitted from a system transmitter.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to wireless networks; more particularly, the present invention relates to software radio applications.

### BACKGROUND

In wireless networking protocols, the determination of whether a transmitted data packet was successfully received at a receiving device is made based upon the receipt of an acknowledge packet at the transmitting device. Thus, tight timing constraints are established for the transmission of data packets and the receipt of corresponding acknowledge packets. In particular, it is imperative in wireless networking protocols to identify when the last symbol of a data packet has been transmitted on air so that the transmitting device can begin to look for the arrival of the corresponding acknowledge packet.

One problem in software radio implementations of wireless networks is that the media access layer (MAC) that controls the system timing is often situated on a processor separate from the processor that transmits the data on air. Thus, the MAC must be informed when the last symbol is transmitted in order keep track of the timing. However, tens of microseconds between the times the MAC transmits the final symbol until the symbol is actually transmitted from the antenna may be required. As a result, there is no way for the MAC to accurately account for the actual transmission time.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a network;

FIG. 2 is a block diagram of one embodiment of a computer system;

FIG. 3 is a block diagram of one embodiment of a software radio;

FIG. 4 is diagram of one embodiment of a ramp on/ramp off occurrence at transceiver; and

FIG. 5 is a flow diagram for one embodiment of determining when a packet transmission ends.

### DETAILED DESCRIPTION

A method for determining the end of a transmission in a software radio having multiple processors is described. According to one embodiment, a media access layer control processor monitors a receive signal strength indicator value after all data symbols have been transmitted from the media access layer processor. Once the media access layer processor recognizes that the signal strength indicator value has fallen below a predetermined threshold value the media access layer processor identifies the transmission of all of the data symbols as being completed.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs), execution cores, etc.).

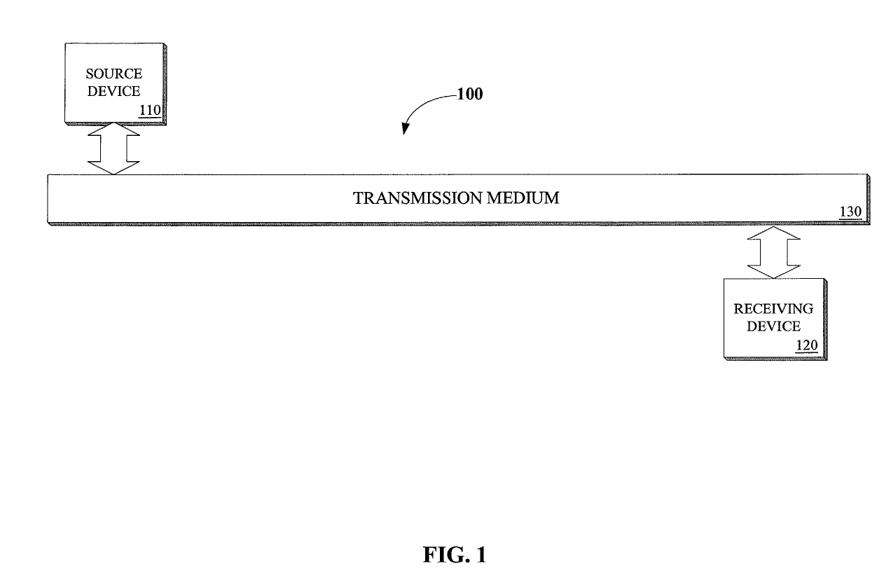

FIG. 1 illustrates one embodiment of a network 100. Network 100 includes a computer system 110 and a computer system 120 coupled via a transmission medium 130. In one embodiment, computer system 110 operates as a source device that sends an object to computer system 120, operating as a receiving device. The object may be, for example, a data file, an executable, or other digital objects. The object is sent via data transmission medium 130. According to one embodiment, data transmission medium 130 is a wireless medium (e.g., air).

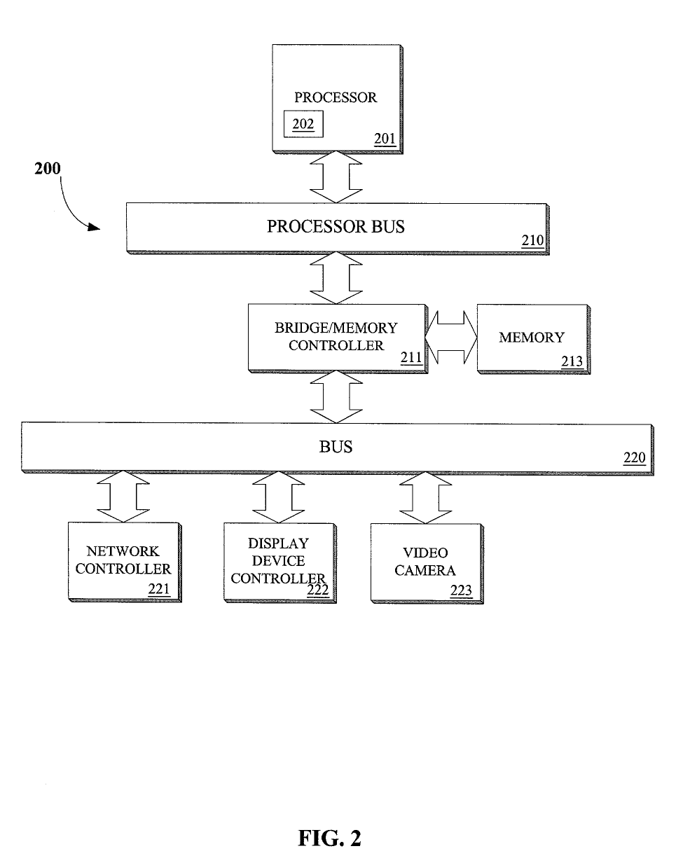

FIG. 2 is a block diagram of one embodiment of a computer system 200. Computer system 200 may be implemented as computer system 110 or computer system 120 (both shown in FIG. 1). The computer system 200 includes a processor 201 that processes data signals. Processor 201 may be a complex instruction set computer (CISC) microprocessor, a reduced instruction set computing (RISC) microprocessor, a very long instruction word (VLIW) microprocessor, a processor implementing a combination of instruction sets, or other processor device.

In one embodiment, processor 201 is a processor in the Pentium® family of processors including the Pentium® 4 family and mobile Pentium® and Pentium® 4 processors available from Intel Corporation of Santa Clara, Calif. Alternatively, other processors may be used. FIG. 2 shows an example of a computer system 200 employing a single processor computer. However, one of ordinary skill in the art will appreciate that computer system 200 may be implemented using multiple processors.

Processor 201 is coupled to a processor bus 210. Processor bus 210 transmits data signals between processor 201 and other components in computer system 200. Computer system 200 also includes a memory 213. In one embodiment, memory 213 is a dynamic random access memory (DRAM) device. However, in other embodiments, memory 213 may be a static random access memory (SRAM) device, or other memory device. Memory 213 may store instructions and code represented by data signals that may be executed by processor 201. According to one embodiment, a cache memory 202 resides within processor 201 and stores data signals that are also stored in memory 213. Cache 202 speeds up memory accesses by processor 201 by taking advantage of its locality of access. In another embodiment, cache 202 resides external to processor 201.

Computer system 200 further comprises a bridge memory controller 211 coupled to processor bus 210 and memory 213. Bridge/memory controller 211 directs data signals between processor 201, memory 213, and other components in computer system 200 and bridges the data signals between processor bus 210, memory 213, and a first input/output (I/O) bus 220. In one embodiment, I/O bus 220 may be a single bus or a combination of multiple buses.

In a further embodiment, I/O bus 220 may be a Peripheral Component Interconnect adhering to a Specification Revision 2.1 bus developed by the PCI Special Interest Group of Portland, Oreg. In another embodiment, I/O bus 220 may be a Personal Computer Memory Card International Association (PCMCIA) bus developed by the PCMCIA of San Jose, Calif. Alternatively, other busses may be used to implement I/O bus. I/O bus 220 provides communication links between components in computer system 200.

A display device controller 222 is also coupled to I/O bus 220. Display device controller 222 allows coupling of a display device to computer system 200, and acts as an interface between the display device and computer system 200. In one embodiment, display device controller 222 is a monochrome display adapter (MDA) card. In other embodiments, display device controller 222 may be a color graphics adapter (CGA) card, an enhanced graphics adapter (EGA) card, an extended graphics array (XGA) card or other display device controller. The display device may be a television set, a computer monitor, a flat panel display or other display device. The display device receives data signals from processor 201 through display device controller 222 and displays the information and data signals to the user of computer system 200. A video camera 223 is also coupled to I/O bus 220.

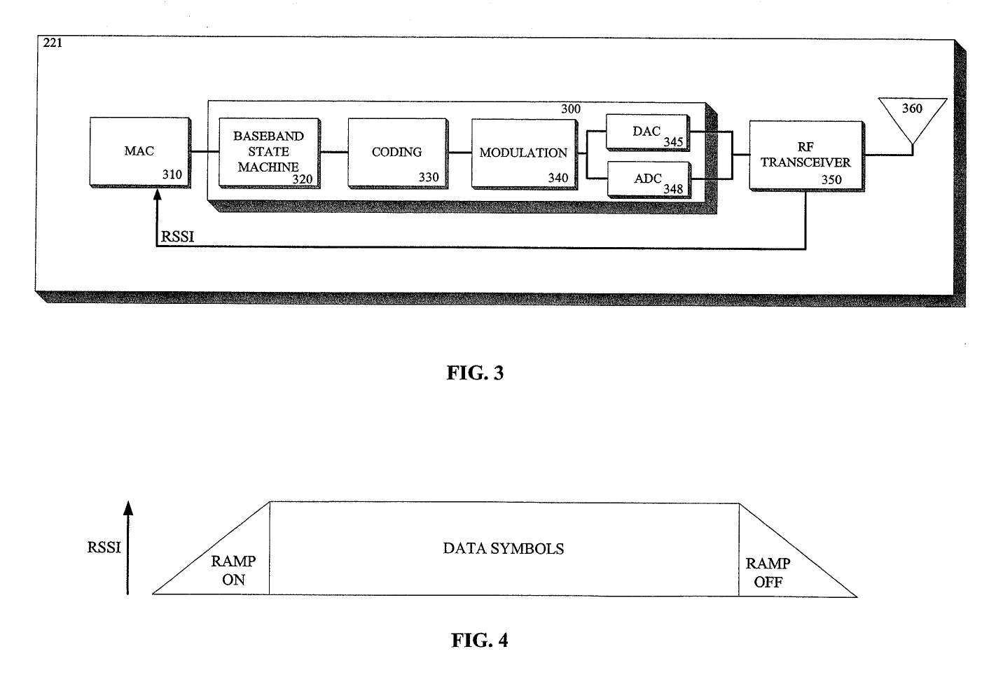

A network controller 221 is coupled to I/O bus 220. Network controller 221 links computer system 200 to a network of computers (not shown in FIG. 2) and supports communication among the machines. According to one embodiment, network controller 221 enables computer system 200 to implement a software radio application via one or more wireless network protocols. FIG. 3 is a block diagram of one embodiment of network controller 221.

Referring to FIG. 3, network controller 221 includes a baseband 300, a media access control layer (MAC) 310, a digital to analog converter (DAC) 345, an analog to digital converter (ADC) 348, a radio frequency (RF) transceiver 350, and an antenna 360. In one embodiment, DSP 300 is an embedded DSP. According to one embodiment, baseband 300, MAC 310, and DAC 345 and ADC 348 are controlled by separate embedded digital signal processors (DSPs). An embedded DSP typically integrates a processor core, a program memory device, and application-specific circuitry on a single integrated circuit die. One of ordinary skill in the art will appreciate that one or more of the DSPs may be replaced with other components (e.g., field programmable gate arrays (FPGAs) without departing from the scope of the invention).

MAC 310 controls the means by which multiple devices share the same media channel of transmission medium 130. According to one embodiment, MAC 310 processes data to be transmitted to another computer system via transmission medium 130. In particular, MAC 310 retrieves data from memory 213 that is to be transmitted from computer system 200. Similarly, MAC 310 receives and processes data packets received at network controller 221. Moreover, MAC 310 controls the timing of transmitted and received data packets at network controller 221. In a further embodiment, MAC 310 determines when a packet transmission at DSP 300 has been completed based upon a receive signal strength indicator (RSSI) value, as will be described in further detail below.

Baseband 300 includes baseband state machine 320, coding 330, and modulation 340. Baseband state machine 320 is coupled to MAC 310 and prepares data received from MAC 310 for transmission. According to one embodiment, baseband state machine 320 performs pseudo-noise code spreading. Moreover, baseband state machine 320 also provides scrambling for interference rejection and antenna diversity for better coverage.

Coding 330 encodes data received from baseband state machine 320 and decodes data received from modulation 340. Coding 330 is used to improve the performance of the wireless radio application of network controller 221. According to one embodiment, coding 330 implements a convolutional code. Convolutional code is a type of error-correction code in which (a) each m-bit information symbol (e.g., each m-bit string) to be encoded is transformed into an n-bit symbol, where n>m and (b) the transformation is a function of the last k information symbols, where k is the constraint length of the code.

Modulation 340 modulates the baseband data to place the data in an intermediate frequency range. Modulation 340 also demodulates data received at network controller 221. DAC 345 is coupled to modulation 345. DAC 345 converts the modulated baseband signal from digital to analog for transmission. ADC 348 converts received analog signals to a digital format prior to de-modulation at modulation 340.

Transceiver 350 is coupled to DAC 345 and ADC 348. Transceiver 350 receives and transmits data from network controller 221 on air. Transceiver 350 includes a power amplifier that amplifies the modulated data packets prior to transmission. Further, transceiver 350 operates in a complementary manner when receiving a packet. Specifically, antenna 360 supplies the received packet to transceiver 350. The packet is then demodulated and decoded to obtain a baseband packet, which it supplied to baseband 320. After processing this packet, baseband 320 notifies MAC 310 that it has received packet data.

In conventional wireless networking protocols, tight timing constraints are established for the transmission of data packets and the receipt of corresponding acknowledge packets in order to minimize data collisions on the shared transmission medium. However, a problem in software radio implementations of wireless networks is that MAC 310, which controls all of the transmit timing, is often located on a separate DSP from the DSP that controls DAC 345. There is some latency between the times MAC 310 transmits the data to baseband state machine 320 until the data arrives at DAC 345. Thus, MAC 310 must be informed when the last symbol is transmitted in order keep track of the timing.

Nonetheless, tens of microseconds between the times the MAC layer transmits the final symbol until the symbol is actually transmitted from the antenna are often required. As a result, there is no way for the MAC to accurately account for the actual transmission time. One method to solve this problem is to have MAC 310 mark the last symbol of a packet. When the DSP that controls DAC 345 recognizes the mark, the DSP will inform MAC 310 that the last symbol has been transmitted. However, this solution requires the DSP controlling DAC 345 to check each and every symbol for the mark, which involves a lot of processor time.

Moreover, the transmitter continues to transmit signals after the data transaction ends due to a ramp off occurrence. Ramp off is an occurrence where the transmitter of transceiver 350 continues to transmit symbols in order to enable the power amplifier to ramp off. Thus, the DSP controlling DAC 345 cannot determine the last symbol of the transmission by the samples for DAC 345 ending since there will be additional samples for the ramp off.

A RSSI signal represents the strength of any signal current being received. One of ordinary skill in the art will recognize that other measurements of signal quality, such as a Signal Quality Estimate (SQE) of the signal, may be implemented without departing from the scope of the invention.

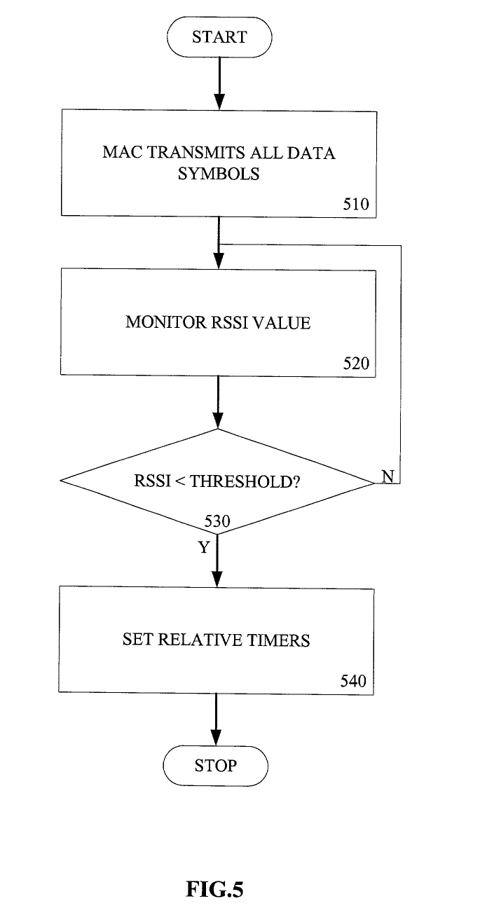

FIG. 4 is diagram of one embodiment of a ramp on/off occurrence at transceiver 350. During the ramp on period, the RSSI gradually rises from zero to a maximum value where data from MAC 310 is transmitted. After the last data symbol is transmitted on air, the RSSI gradually drops from the maximum value back to zero. This is referred to as the ramp off period.

According to one embodiment, MAC 310 monitors the RSSI value received from transceiver 350 after all of the data symbols have been transmitted from MAC 310 in order to determine when the value falls below a predetermined threshold. Once MAC 310 determines that the value falls below the threshold, MAC 310 identifies that the last data symbol has been transmitted. Referring back to FIG. 3, MAC 310 includes relative timers that determine when MAC 310 can next transmit.

In one embodiment, a carrier sense multiple access protocol is implemented at network interface 221 to arbitrate for control. To minimize the chance for collisions, there are certain times when MAC 310 can transmit on the transmission medium. The time when MAC 310 can transmit is based upon the time the last transmit ended. Therefore, It is important that MAC 310 recognize this time or it cannot comply with wireless protocol specifications and will cause undue collisions on the network.

FIG. 5 is a flow diagram for one embodiment of determining when a packet transmission across multiple processors ends. At process block 510, MAC 310 transmits all data symbols to the next processing element. In one embodiment, the next processing element is baseband 320. However, in other embodiments, one or more of the other processing elements (e.g., baseband, coding and/or modulation) may be located on the same processing element. At process block 520, MAC 310 monitors the RSSI value received from transceiver 350.

At process block 530, MAC 310 determines whether the RSSI value is below the predetermined threshold. If not, MAC 310 control is returned to process block 520 where MAC 310 continues to monitor the RSSI value. Once MAC 310 identifies that the RSSI value is below the predetermined threshold, the relative timers are set based upon the current time, process block 540. MAC 310 uses the relative timers to determine when the next time it can transmit. As described above, the next time at which MAC 310 can transmit is based upon the implemented wireless protocol.

The above-described method takes advantage of values that are already calculated in wireless networking systems. Therefore, the implemented hardware and software are already present.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

[image]

What is claimed is:

1. A method comprising:
transmitting data symbols from a media access control layer (MAC) processing element to a second processor; and
monitoring a receive signal strength indicator (RSSI) value to determine if the data symbols have been completely transmitted from a system transmitter.

2. The method of claim 1 further comprising determining whether the RSSI value drops below a predetermined threshold.

3. The method of claim 2 further comprising monitoring the RSSI value if it is determined that the RSSI value has not dropped below the predetermined threshold.

4. The method of claim 2 further comprising setting one or more timers if it is determined that the RSSI value has dropped below the predetermined threshold.

5. The method of claim 1 wherein the second processor is a baseband processor.

6. A computer system comprising a network controller, the network controller including a media access layer (MAC) digital signal processor (DSP) that monitors a receive signal strength indicator (RSSI) value to identify that the transmission of all data symbols from the network controller has been completed.

7. The computer system of claim 6 wherein the network controller further comprises a baseband DSP coupled to the MAC DSP, wherein the MAC DSP begins to monitor the RSSI value after all data symbols have been transmitted from the media access layer DSP to the baseband DSP.

8. The computer system of claim 7 wherein the baseband DSP comprises:
a baseband state machine;
a coding element coupled to the baseband state machine; and
a modulation element coupled to the coding.

9. The computer system of claim 8 wherein the network controller further comprises:
a digital to analog converter (DAC) DSP coupled to the baseband DSP; and
an analog to digital converter (ADC) DSP coupled to the baseband DSP.

10. The computer system of claim 9 wherein the network controller further comprises:
a transceiver that transmits the RSSI to the MAC DSP; and
an antenna coupled to the transceiver.

11. The computer system of claim 1 further comprising:
a system input/output (I/O) bus coupled to the network controller;
a bridge/memory controller coupled to the system I/O bus; and
a processor coupled to the bridge/memory controller.

12. A network controller comprising:
a media access layer (MAC) digital signal processor (DSP) that monitors a receive signal strength indicator (RSSI) value to identify that the transmission of all data symbols from the network controller has been completed;
a baseband DSP, coupled to the MAC DSP; and
a digital to audio converter DSP coupled to the baseband DSP.

13. The network controller of claim 12 wherein the baseband DSP comprises:
a baseband state machine;
a coding element coupled to the baseband state machine; and
a modulation element coupled to the coding element.

14. The network controller of claim 12 further comprising:
a transceiver, coupled to the DAC DSP, that transmits the RSSI to the MAC DSP; and
an antenna coupled to the transceiver.

15. An article of manufacture including one or more computer readable media that embody a program of instructions wherein the program of instructions, when executed by a processing unit, causes the processing unit to:
transmit data symbols from a media access control layer (MAC); and
monitor a receive signal strength indicator (RSSI) value to determine if the data symbols have been completely transmitted from a system transmitter.

16. The article of manufacture of claim 15 wherein the program of instructions, when executed by a processing unit, further causes the processing unit to determine whether the RSSI value drops below a predetermined threshold.

17. The method of claim 16 wherein the program of instructions, when executed by a processing unit, further causes the processing unit to monitor the RSSI value if it is determined that the RSSI value has not dropped below the predetermined threshold.

18. The method of claim 16 wherein the program of instructions, when executed by a processing unit, further causes the processing unit to set one or more timers if it is determined that the RSSI value has dropped below the predetermined threshold.
